(19) United States
(12) Patent Application Publication
(10) Pub. No.: US 2024/0418886 A1
(43) Pub. Date: Dec. 19, 2024

(54) Image Warping Optimization Framework For Post-Stack Seismic Survey Merging

(71) Applicant: Landmark Graphics Corporation, Houston, TX (US)

(72) Inventors: Daniel Thomas-Possee, Abingdon (GB); Satyan Singh, Abingdon (GB); Graham Baines, Abingdon (GB); Konstantin Osypov, Houston, TX (US); Chaoshun Hu, Houston, TX (US)

(73) Assignee: Landmark Graphics Corporation, Houston, TX (US)

(21) Appl. No.: 18/414,336

(22) Filed: Jan. 16, 2024

Related U.S. Application Data
(60) Provisional application No. 63/472,765, filed on Jun. 13, 2023.

(51) Int. Cl. G01V 1/28

(52) U.S. Cl. CPC G01V 1/28; G01V 2210/514

(57) ABSTRACT

A method for generating a merged survey dataset, that includes obtaining a plurality of survey datasets, calculating edges between survey datasets of the plurality of survey datasets, modifying the plurality of survey datasets, based on the edges, to obtain a plurality of modified survey datasets, and generating the merged survey dataset using the plurality of modified survey datasets.

### CROSS-REFERENCE TO RELATED APPLICATIONS

This is a nonprovisional application claiming priority to U.S. Provisional Patent Application No. 63/472,765, filed Jun. 13, 2023, the entirety of which is incorporated herein by reference.

### BACKGROUND

The oil and gas industry may use seismology to gather data about subterranean formations and structures, in pursuit of locating resource deposits. In some cases, seismology data is gathered over a body of water using a vessel and an array of sensors towed over the water. Raw data gathered in such environments may need to be processed before the data can be analyzed for locating resource deposits. Tools to process the data may involve human input and produce data that is not ideal for analysis.

### BRIEF DESCRIPTION OF DRAWINGS

These drawings illustrate certain aspects of some examples of the present disclosure and should not be used to limit or define the disclosure.

FIG. 1 is a diagram of an example surveying environment.

FIG. 2 is a diagram of an example computing environment.

FIG. 3A is a diagram of two example processed survey datasets.

FIG. 3B is a diagram of a nonsmooth merged dataset.

FIG. 3C is a diagram showing edges between the two example processed survey datasets.

FIG. 3D is an example of two modified datasets.

FIG. 3E is an example of merged dataset.

FIG. 4 is a diagram of two survey datasets and the edges between them.

FIG. 5 is a flowchart of a method for generating a merged dataset from multiple datasets.

### DETAILED DESCRIPTION

### Overview and Advantages

In general, this application discloses one or more embodiments of methods and systems for merging seismic data, from multiple datasets, into unified dataset.

In conventional systems, seismic data is captured over some geographic region (on land and/or sea) and subsequently processed for geophysical analysis. At some point later, seismic data may be captured over the same (or at least partially overlapping) geographic region. Similarly, that data will be processed for further analysis. Generally, processing data is time consuming, computationally expensive, and requires expert technical input.

In some circumstances, it may be desirable to merge (or otherwise combine) the independent seismic datasets into a single, unified dataset so that the larger dataset may be analyzed, as a whole. However, combining already-processed survey datasets results in discontinuous, nonsmoothed merged datasets where it is apparent the merged dataset is an amalgamation of multiple seismic datasets.

Already-processed datasets may not be easily combined into a unified and processed dataset. Rather, reprocessing a larger dataset is often required, costing further, time, resources, and expense. Accordingly, conventional techniques to combine datasets require first merging the pre-processed and raw seismic data and then processing the entirety of the raw data, as a single dataset, to produce a single processed merged dataset.

In some instances, where four (or higher) dimensional structures are present, legacy survey datasets and the new higher-resolution survey datasets are gathered along the same geometry line, with overlapping geography (e.g., surveys taken over the same geographic region at different times, partially processed raw seismic data of the same region processed from different angles, captured and/or processed from different azimuths, etc.). However, in most places, the overlapping of the legacy data and new data is very small or almost none. In addition, seismic interpretation may be present, which involves complex fault patterns, subtle stratigraphic plays or reservoir extent. In such cases more accurate stratigraphic interpretation is required, but the available bandwidth of seismic data may be insufficient to image the proper resolution of the target.

As disclosed in one or more embodiments herein, methods are provided for generating a merged dataset using multiple sets of already-processed data. Further, the techniques described herein provide a method for generating “smooth” merged datasets, where any reflectors of the data are seamlessly continuous across the boundaries of the smaller datasets. Accordingly, in scenarios where raw, pre-processed seismic data is unavailable, or computational time and expense are undesirable, the methods and systems disclosed herein provide for directly merging already-processed survey datasets into a single, unified, and processed merged dataset which may be generated more quickly than when using conventional methods.

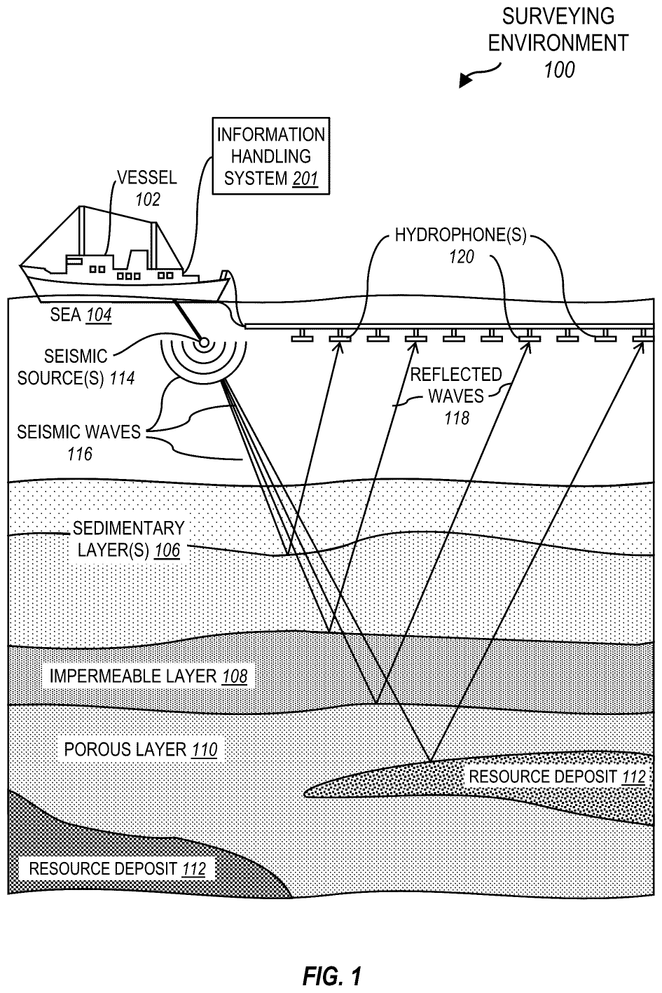

### FIG. 1

FIG. 1 is a diagram of an example surveying environment. Surveying environment 100 may include vessel 102 on sea 104, using seismology to generate and collect data related to one or more resource deposit(s) 112. Each of these components is described below.

Vessel 102 is a structure used to support one or more seismic source(s) 114 and one or more hydrophone(s) 120. In any embodiment, vessel 102 may be less dense than the liquid composing sea 104, and therefore vessel 102 will have buoyancy sufficient to prevent the entirety of vessel 102 from submerging into sea 104. Vessel 102 may navigate on the surface of sea 104 to move one or more seismic source(s) 114 and one or more hydrophone(s) 120 to regions where seismic data may be collected (e.g., into information handling system 201).

Sea 104 is a body of (mostly) water, upon which vessel 102 may float. In any embodiment, non-limiting examples of sea 104 include an ocean, gulf, lake, pond, reservoir, river, and stream.

Sedimentary layer 106 is a collection of minerals (e.g., rocks) and/or organic matter forming a seabed in sea 104. Sedimentary layer 106 is porous as the liquid(s) of sea 104 may interstitially penetrate between the individual objects forming sedimentary layer 106.

Impermeable layer 108 is a formation of nonporous rock through which the liquid(s) of sea 104 cannot penetrate. In any embodiment, impermeable layer 108 separates two porous layers (e.g., sedimentary layer 106, porous layer 110). Impermeable layer 108 may act to prevent the diffusion of fluids in one or more resource deposit(s) 112 with sea 104, as the fluids thereof are kept physically isolated by the low porosity of impermeable layer 108.

Porous layer 110 is a formation of rocks which allows for the flow of fluids (i.e., gases and/or liquids) to move therein. A non-limiting example of porous layer 110 is an aquifer providing for the movement and storage of groundwater. In any embodiment, porous layer 110 allows for the movement and storage of resource deposit(s) 112.

Resource deposit 112 is an aggregation of matter, where the matter may store energy in the chemical bonds (i.e., a resource). Non-limiting examples of a resource are any fluid hydrocarbon (e.g., petroleum, natural gas, etc.).

Seismic source 114 is a hardware device which generates seismic waves 116. In any embodiment, seismic source 114 may be controlled via information handling system 201 and periodically generate seismic waves 116 (e.g., on a schedule, and/or manually activated by a user). Non-limiting examples of seismic source 114 include a seismic airgun which releases a burst of compressed gas, an electrical discharge sound device (e.g., boomers, sparkers, etc.), and a sonic navigation and ranging (sonar) device.

Seismic waves 116 are acoustic waves, generated from seismic source 114, manifesting as changes in pressure (e.g., changes in the density of fluid(s)) that propagate through sea 104, sedimentary layer(s) 106, impermeable layer 108, porous layer 110, and resource deposit(s) 112. Seismic waves 116 may travel in all directions from seismic source 114 (e.g., spherically outward).

Reflected waves 118 are seismic waves 116 that have reflected (e.g., “bounced”) off one or more object(s) in sea 104, sedimentary layer(s) 106, impermeable layer 108, porous layer 110, or resource deposit(s) 112. In any embodiment, after reflecting, reflected waves 118 may be (re)directed in all directions (e.g., spherically outward), including towards hydrophone(s) 120. When seismic waves 116 interact and reflect off one or more objects in the various layer(s), the resulting reflected waves 118 may be altered (via a change in amplitude, frequency, etc.) from the original seismic waves 116. As non-limiting examples, (unaltered) seismic waves 116 may have a different frequency, phase, and/or amplitude than reflected waves 118 emanating from impermeable layer 108, which may also have a different frequency than reflected waves 118 emanating from resource deposit 112. Additionally, in any embodiment, reflected waves 118 that penetrate further into the various layers (e.g., into porous layer 110) may take a longer duration to travel deeper, reflect off of an object, travel back upward, and impact hydrophone 120, compared to reflected waves 118 that bounce back from a shallower depth (e.g., in sedimentary layer 106).

Hydrophone 120 is a hardware device (e.g., a microphone) which detects sounds in a liquid environment (e.g., seismic waves 116, reflected waves 118). Hydrophone 120 may work by detecting changes in pressure caused by sounds (e.g., from seismic waves 116, reflected waves 118) and converting those detected pressure changes into data. In any embodiment, hydrophone 120 may be configured to detect the amplitude, frequency, and/or time of detected sounds. Hydrophone 120 may be operatively connected to information handling system 201, where generated data may be stored.

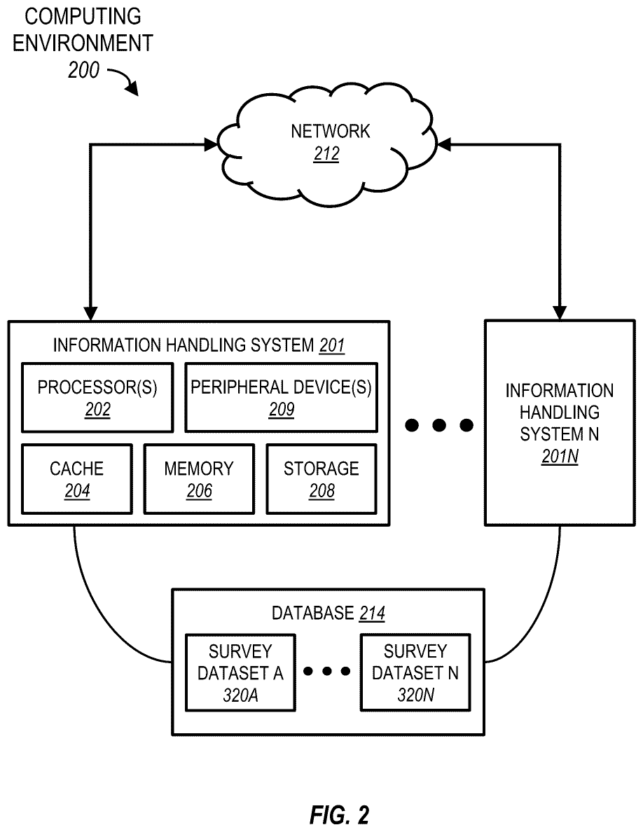

Information handling system 201 is a hardware computing system which may be operatively connected to vessel 102 (and/or other various components of the surveying environment 100). In any embodiment, information handling system 201 may utilize any suitable form of wired and/or wireless communication to send and/or receive data to and/or from other components of surveying environment 100. In any embodiment, information handling system 201 may receive a digital telemetry signal, demodulate the signal, display data (e.g., via a visual output device), and/or store the data. In any embodiment, information handling system 201 may send a signal (with data) to one or more components of surveying environment 100 (e.g., to control seismic source 114, hydrophone(s) 120, vessel 102, etc.). Additional details regarding information handling system 201 are in the description for FIG. 2.

### FIG. 2

FIG. 2 is a diagram of an example computing environment. Computing environment 200 may include one or more information handling system(s) 201 connected via network 212. Each of these components is described below.

Information handling system 201 is a hardware computing device which may be utilized to perform various steps, methods, and techniques disclosed herein (e.g., via the execution of software). In any embodiment, information handling system 201 may include one or more processor(s) 202, cache 204, memory 206, storage 208, and/or one or more peripheral device(s) 210. Any two or more of these components may be operatively connected via a system bus (not shown) that provides a means for transferring data between those components. Although each component is depicted and disclosed as individual functional components, these individual components may be combined (or divided) into any combination or configuration of components.

A system bus is a system of hardware connections (e.g., sockets, ports, wiring, conductive tracings on a printed circuit board (PCB), etc.) used for sending (and receiving) data to (and from) each of the components connected thereto. In any embodiment, a system bus allows for communication via an interface and protocol (e.g., inter-integrated circuit (I2C), peripheral component interconnect (express) (PCI(e)) fabric, etc.) that may be commonly recognized by the components utilizing the system bus. In any embodiment, a basic input/output system (BIOS) may be configured to transfer information between the components using the system bus (e.g., during initialization of information handling system 201).

In any embodiment, information handling system 201 may additionally include internal physical interface(s) (e.g., serial advanced technology attachment (SATA) ports, peripheral component interconnect (PCI) ports, PCI express (PCIe) ports, next generation form factor (NGFF) ports, M.2 ports, etc.) and/or external physical interface(s) (e.g., universal serial bus (USB) ports, recommended standard (RS) serial ports, audio/visual ports, etc.). Internal physical interface(s) and external physical interface(s) may facilitate the operative connection to one or more peripheral device(s) 210.

Non-limiting examples of information handling system 201 include a general purpose computer (e.g., a personal computer, desktop, laptop, tablet, smart phone, etc.), a network device (e.g., switch, router, multi-layer switch, etc.), a server (e.g., a blade-server in a blade-server chassis, a rack server in a rack, etc.), a controller (e.g., a programmable logic controller (PLC)), and/or any other type of computing device with the aforementioned capabilities. Further, information handling system 201 may be operatively connected to another information handling system 201 via network 212 in a distributed computing environment. As used herein, a “computing device” may be equivalent to an information handling system.

Processor 202 is a hardware device which may take the form of an integrated circuit configured to process computer-executable instructions (e.g., software). Processor 202 may execute (e.g., read and process) computer-executable instructions stored in cache 204, memory 206, and/or storage 208. Processor 202 may be a self-contained computing system, including a system bus, memory, cache, and/or any other components of a computing device. Processor 202 may include multiple processors, such as a system having multiple, physically separate processors in different sockets, or a system having multiple processor cores on a single physical chip. A multi-core processor may be symmetric or asymmetric. Multiple processors 202, and/or processor cores thereof, may share resources (e.g., cache 204, memory 206) or may operate using independent resources.

Non-limiting examples of processor 202 include general-purpose processor (e.g., a central processing unit (CPU)), an application specific integrated circuit (ASIC), a programmable gate array (PGA), a field programmable gate array (FPGA), a digital signal processor (DSP), and any digital or analog circuit configured to perform operations based on input data (e.g., execute program instructions).

Cache 204 is one or more hardware device(s) capable of storing digital information (e.g., data) in a non-transitory medium. Cache 204 expressly excludes transitory media (e.g., transitory waves, energy, carrier signals, electromagnetic waves, signals per se, etc.). Cache 204 may be considered “high-speed”, having comparatively faster read/write access than memory 206 and storage 208, and therefore utilized by processor 202 to process data more quickly than data stored in memory 206 or storage 208. Accordingly, processor 202 may copy needed data to cache 204 (from memory 206 and/or storage 208) for comparatively speedier access when processing that data. In any embodiment, cache 204 may be included in processor 202 (e.g., as a subcomponent). In any embodiment, cache 204 may be physically independent, but operatively connected to processor 202.

Memory 206 is one or more hardware device(s) capable of storing digital information (e.g., data) in a non-transitory medium. Memory 206 expressly excludes transitory media (e.g., transitory waves, energy, carrier signals, electromagnetic waves, signals per se, etc.). In any embodiment, when accessing memory 206, software (executed via processor 202) may be capable of reading and writing data at the smallest units of data normally accessible (e.g., “bytes”). Specifically, memory 206 may include a unique physical address for each byte stored thereon, thereby enabling the ability to access and manipulate (read and write) data by directing commands to a specific physical address associated with a byte of data (i.e., “random access”). Non-limiting examples of memory 206 devices include flash memory, random access memory (RAM), dynamic RAM (DRAM), static RAM (SRAM), resistive RAM (ReRAM), read-only memory (ROM), and electrically erasable programmable ROM (EEPROM). In any embodiment, memory 206 devices may be volatile or non-volatile.

Storage 208 is one or more hardware device(s) capable of storing digital information (e.g., data) in a non-transitory medium. Storage 208 expressly excludes transitory media (e.g., transitory waves, energy, carrier signals, electromagnetic waves, signals per se, etc.). In any embodiment, the smallest unit of data readable from storage 208 may be a “block” (instead of a “byte”). Prior to reading and/or manipulating the data on storage 208, one or more block(s) may be copied to an intermediary storage medium (e.g., cache 204, memory 206) where the data may then be accessed in “bytes” (e.g., via random access). In any embodiment, data on storage 208 may be accessed in “bytes” (like memory 206). Non-limiting examples of storage 208 include integrated circuit storage devices (e.g., a solid-state drive (SSD), Non-Volatile Memory Express (NVMe), flash memory, etc.), magnetic storage devices (e.g., a hard disk drive (HDD), floppy disk, magnetic tape, diskette, cassettes, etc.), optical media (e.g., a compact disc (CD), digital versatile disc (DVD), etc.), and printed media (e.g., barcode, quick response (QR) code, punch card, etc.).

As used herein, “non-transitory computer readable medium” is cache 204, memory 206, storage 208, and/or any other hardware device capable of non-transitorily storing and/or carrying data.

Peripheral device 210 is a hardware device configured to send (and/or receive) data to (and/or from) information handling system 201 via one or more internal and/or external physical interface(s). Any peripheral device 210 may be categorized as one or more “types” of computing devices (e.g., an “input” device, “output” device, “communication” device, etc.). However, such categories are not comprehensive and are not mutually exclusive. Such categories are listed herein strictly to provide understandable groupings of the potential types of peripheral devices 210. As such, peripheral device 210 may be an input device, an output device, a communication device, and/or any other optional computing component.

An input device is a hardware device that receives data into information handling system 201. In any embodiment, an input device may be a human interface device which facilitates user interaction by collecting data based on user inputs (e.g., a mouse, keyboard, camera, microphone, touchpad, touchscreen, fingerprint reader, joystick, gamepad, etc.). In any embodiment, an input device may collect data based on raw inputs, regardless of human interaction (e.g., any sensor, logging tool, audio/video capture card, etc.). In any embodiment, an input device may be a reader for accessing data on a non-transitory computer readable medium (e.g., a CD drive, floppy disk drive, tape drive, scanner, etc.).

An output device is a hardware device that sends data from information handling system 201. In any embodiment, an output device may be a human interface device which facilitates providing data to a user (e.g., a visual display monitor, speakers, printer, status light, haptic feedback device, etc.). In any embodiment, an output device may be a writer for facilitating storage of data on a non-transitory computer readable medium (e.g., a CD drive, floppy disk drive, magnetic tape drive, printer, etc.).

A communication device is a hardware device capable of sending and/or receiving data with one or more other communication device(s) (e.g., connected to another information handling system 201 via network 212). A communication device may communicate via any suitable form of wired interface (e.g., Ethernet, fiber optic, serial communication etc.) and/or wireless interface (e.g., Wi-Fi® (Institute of Electrical and Electronics Engineers (IEEE) 802.11), Bluetooth® (IEEE 802.15.1), etc.) and utilize one or more protocol(s) for the transmission and receipt of data (e.g., transmission control protocol (TCP), user datagram protocol (UDP), internet protocol (IP), remote direct memory access (RDMA), etc.). Non-limiting examples of a communication device include a network interface card (NIC), a modem, an Ethernet card/adapter, and a Wi-Fi® card/adapter.

An optional computing component is any hardware device that operatively connects to information handling system 201 and extends the capabilities of information handling system 201. Non-limiting examples of an optional computing components include a graphics processing unit (GPU), a data processing unit (DPU), and a docking station.

As used herein, “software” (e.g., “code”, “algorithm”, “application”, “routine”) is data in the form of computer-executable instructions. Processor 202 may execute (e.g., read and process) software to perform one or more function(s). Non-limiting examples of functions may include reading existing data, modifying existing data, generating new data, and using any capability of information handling system 201 (e.g., reading existing data from memory 206, generating new data from the existing data, sending the generated data to a GPU to be displayed on a monitor). Although software physically persists in cache 204, memory 206, and/or storage 208, one or more software instances may be depicted, in the figures, as an external component of any information handling system 201 that interacts with one or more information handling system(s) 201.

Network 212 is a collection of connected information handling systems (e.g., 201, 201N) that allows for the exchange of data and/or the sharing of computing resources therebetween. Non-limiting examples of network 212 include a local area network (LAN), a wide area network (WAN) (e.g., the Internet), a mobile network, any combination thereof, and any other type of network that allows for the communication of data and sharing of resources among computing devices operatively connected thereto. A person of ordinary skill in the relevant art, having the benefit of this detailed description, would appreciate that a network is a collection of operatively connected computing devices that enables communication between those computing devices.

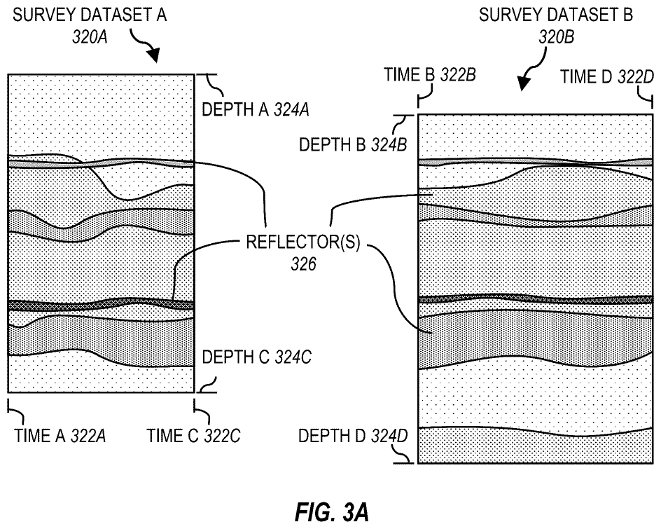

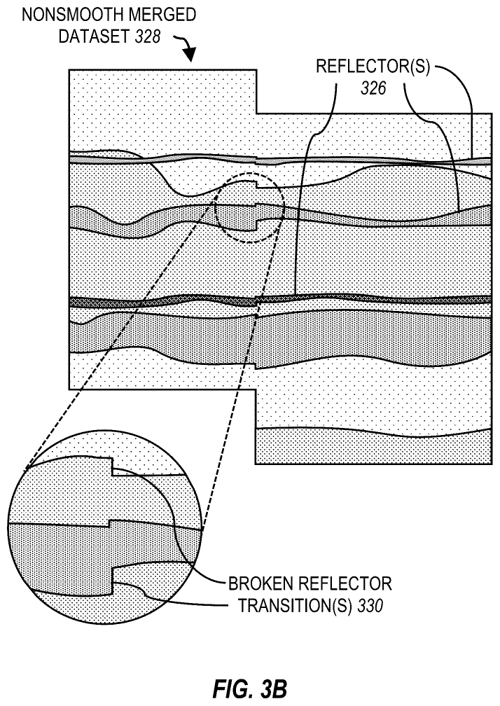

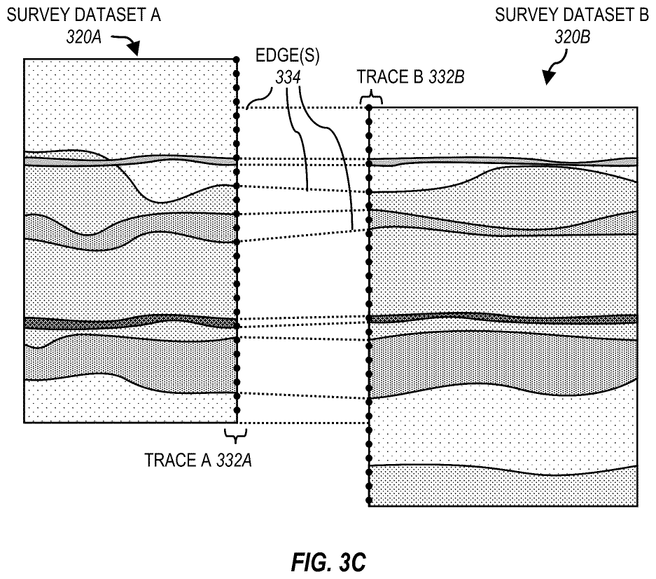

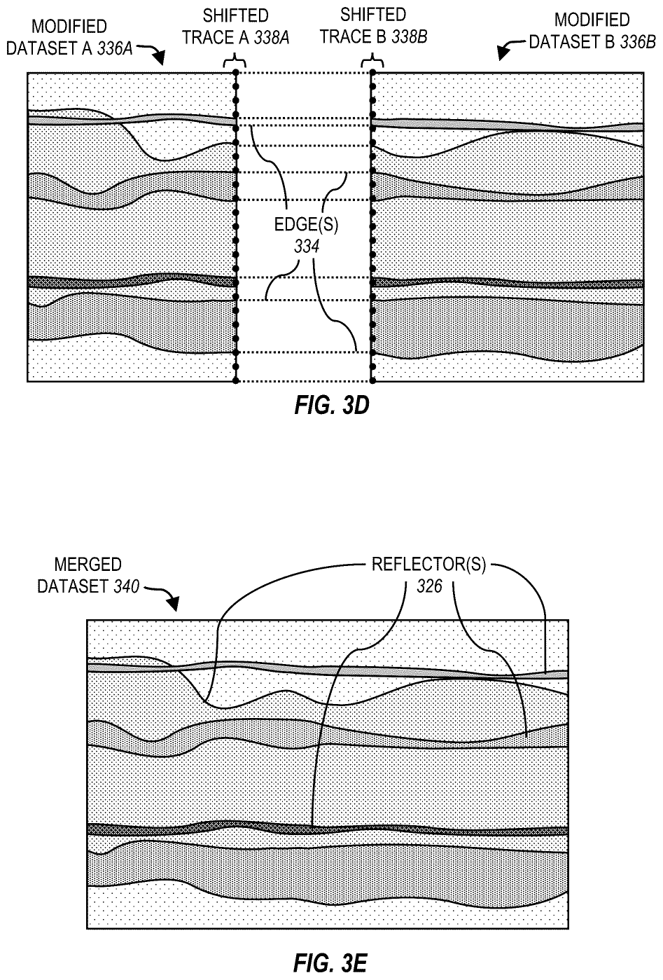

Database 214 is a data structure. In any embodiment, database 214 may be stored on storage 208, memory 206, cache 204 of one or more information handling system(s) 201. Non-limiting examples of database 214 include a table, a structured file for storing tabular data (e.g., a comma-separated value (CSV) file, a tab-separated value (TSV) file, etc.), and/or any other data structure capable of storing data. In one or more embodiments, database 214 may store one or more survey dataset(s) 320, described further in FIGS. 3A-E.

### FIG. 3

FIG. 3A is a diagram of two example processed survey datasets. FIG. 3B is a diagram of a nonsmooth merged dataset. FIG. 3C is a diagram showing edges between the two example processed survey datasets. FIG. 3D is an example of two modified datasets. FIG. 3E is an example of a merged dataset.

Survey dataset 320 is seismic data that has been processed (e.g., “post-stack” seismic data) which may be readied for analysis. In one or more embodiments, any one survey dataset 320 may be generated using a single processing stack for unprocessed (i.e., raw) seismic data. As a non-limiting example, raw seismic data for a geographic region may be combined (e.g., with other, overlapping/neighboring raw seismic data), parsed into smaller portions, and/or some combination thereof. Then, once the raw seismic data is processed (e.g., through a processing stack to prepare the data for analysis), survey dataset 320 is produced as the output.

Position 322 is a datapoint on the positional axis of survey dataset 320. In one or more embodiments, the positional axis is the horizontal axis for survey datasets 320 that may correlate to a spatial dimension of the underlying data. As a non-limiting example, as vessel 102 navigates across sea 104, data for survey dataset 320 is gathered. Depending on the relative velocity of vessel 102, the lateral distances and geographic locations can be associated with position(s) 322. Further, depending on the perspective of the analysis, position(s) 322 may vary or remain constant (e.g., when viewing a dimension of data that was gathered simultaneously, perpendicular to vessel's 102 motion). In one or more embodiments, position(s) 322 may be relative to a coordinate system internal to survey dataset 320 (an “internal coordinate system”). That is, as a non-limiting example, position A 322A may start at “0” arbitrarily without reference to coordinates existing outside of survey dataset A 320A (an “external coordinate system”). In one or more embodiments, relationship(s) between position(s) 322 and external coordinates may be known and used to provide a spatial association with any other dataset that can be related via those external coordinates. As a non-limiting example, position A 322A (of survey dataset 320A) may be associated with a first global positioning system (GPS) coordinate while position B 322B (or survey dataset B 320B) may be associated with a second GPS coordinate. Thus, position A 322A and position B 322B may be spatially related via their GPS coordinates in a common space using an external coordinate system. Further, in one or more embodiments, positions (e.g., 322A, 322B) may be associated across survey datasets (e.g., 320A, 320B) based on a common internal marker present within each dataset thereby providing a spatial association that is “internal”.

Depth 324 is a datapoint on the depth (i.e., vertical) axis of survey dataset 320. In one or more embodiments, depth 324 is calculated using the time (i.e., duration) that seismic wave(s) 116 return as reflected wave(s) 118 (i.e., ‘two-way travel times’). The domain of depth 324 may be parallel to a domain for time, where the same raw data recorded and processed in time may instead (or additionally) be processed into depths using seismic velocities of the medium through which the seismic waves travel, which correlate to the measurement and capture of seismic wave(s) 116 and reflected wave(s) 118. One of ordinary skill in the art (having the benefit of this detailed description) would appreciate that any use of “depth” herein may be substituted with “time” and still allow for the same processing and analysis. Depth 324 may vary and/or be corrected due to swells in sea 104 (causing vertical motion of vessel 102) and/or various other geometric considerations of the capture techniques. Similar to position 322, depth 324 may use an internal coordinate system that is arbitrarily defined within survey dataset 320, but where that internal coordinate system may be spatially related to an external coordinate system thereby enabling spatial relationships across survey datasets 320.

Reflector 326 is data that may correspond to various subterranean formations and geology. In one or more embodiments, reflector(s) 326 may show the relative location of resource deposit(s) 112 with respect to other geological formations (e.g., porous layer(s) 110, impermeable layer(s) 108, etc.). Reflector(s) 326, in survey dataset 320, may correlate resource deposit(s) 112 to known external coordinates (e.g., GPS coordinates), thereby allowing for extraction of those resource deposit(s) 112.

Nonsmooth merged dataset 328 is the combination of two (or more) survey datasets 320 that have not been processed for merging. In one or more embodiments, when multiple survey datasets 320 are combined, there are likely to be broken reflector transition(s) 330 due to underlying differences in the collection and/or processing of survey datasets 320.

Broken reflector transition 330 is an abrupt (e.g., not smooth and/or not continuous) change in reflector 326 within nonsmooth merged dataset 328. In one or more embodiments, broken reflector transitions 330 may be generated when survey datasets 320 are merged without prior processing and/or modification. Differing seismic sources or acquisition parameters (e.g., number of geophones, depth of streamer, etc.) when each survey dataset 320 was captured, differing migrations, and/or differing processing of survey datasets 320 may cause discrepancies between survey datasets 320 when capturing data over the same geographic region (and for the same reflectors 326). Accordingly, in one or more embodiments, it is unlikely that independently developed survey datasets 320 would seamlessly merge, even when merging over an overlapping geographic region.

Trace 332 is a one-dimensional array of data in survey dataset 320. In one or more embodiments, trace(s) 332 may be along position 322 axis, depth 324 axis, and/or any other dimensional axis within survey dataset 320 (e.g., frequency, amplitude, etc.). Trace(s) 332 along the boundaries of survey dataset(s) 320 may be modified by edge(s) 334 to generate shifted trace(s) 338.

Edge 334 is data describing a relationship between two points on two different traces 332. In one or more embodiments, when edge 334 is generated between two traces 332 of two different survey datasets 320, edges 334 may include data interpolating the individual points across those traces 332. As a non-limiting example, if the associated traces 332 do not fully overlap the same geographic region (e.g., having a small gap between them), edges 334 generated between those traces 332 may include newly generated data that provides a continuation of the traces 332, from both sides, to provide a bridge between the independent datasets. In one or more embodiments, edge 334 may further include shifts, where a shift is data describing a modification to associate the data point(s) of one trace 332 with the associated data point(s) at another trace 332. As a non-limiting example, the values of trace 332 may be modified to provide smoothness and continuity of reflector(s) 326 within merged dataset 340 when relating two data points in overlapping and/or adjacent regions.

Modified dataset 336 (i.e., “modified survey dataset”) is the output and/or processed result of applying shifts, from edge(s) 334, to trace(s) 332 of an entire survey dataset 320. In one or more embodiments, modified dataset 336 includes shifted trace(s) 338 modified from original trace(s) 332 to provide for smoother merging of modified datasets 336.

Shifted trace 338 is a one-dimensional array of modified dataset 336 generated from trace 332 of survey dataset 320. In one or more embodiments, shifted trace 338 is generated by applying shifts of edge 334 to trace 332 (i.e., modifying trace 332 as specified in edge 334) to

Merged dataset 340 (i.e., “merged survey dataset”) is a combination of modified dataset(s) 336 that form a single data structure. In one or more embodiments, when completed, merged dataset 340 is a processed survey dataset 320 that may be used for analysis, as another other survey dataset 320.

In the example of FIG. 3A, two survey datasets are produced with overlapping (relative) positions 322 and depths 324. Survey dataset A 320A may have been generated from separate raw seismic data than the raw seismic data used to generate survey dataset B 320B (e.g., the raw seismic data may have been captured and processed years apart).

In the example of FIG. 3B, directly merging the two survey datasets produced nonsmooth merged dataset 328 which includes broken reflector transitions(s) 330. Accordingly, the original survey dataset A 320A and survey dataset B 320B need to be modified prior to merging.

In the example of FIG. 3C, the two survey datasets are shown with respective traces (i.e., trace A 332A and trace B 332B, shown as a one-dimensional array for points along the boundary of the survey datasets). Further, edge(s) 334 are drawn between points of traces 332 that are associated. As can be seen in the example, edges 334 may have varying angles, depending the association of mapped points on traces 332 (correlating to reflectors 326 in each survey dataset 320).

In the example of FIG. 3D, two modified datasets 336 (i.e., modified dataset A 336A and modified dataset B 336B) are depicted with shifted traces 338 (i.e., shifted trace A 338A and shifted trace B 338B). When modified, the shifts of edges 334 are incorporated (i.e., into shifted traces 338) thereby causing edges 334 to be more relatively parallel (e.g., depending on the constraint criteria of the merging and modification algorithms).

In the example of FIG. 3E, a single merged dataset 340 is shown, as generated from the combination of modified dataset A 336A and modified dataset B 336B. As shown, unlike nonsmooth merged dataset 328, reflector(s) 326 are smooth and continuous across merged dataset 340 (e.g., without broken reflector transitions(s) 330). FIGS. 3A, 3C, 3D, and 3E illustrates a successful application of shifts calculated by graph optimization that maps a survey dataset A 320A and survey dataset B 320B into the same position/depth merged dataset 340 such that reflector(s) 326 are continuous and smooth across the underlying survey datasets (320A, 320B).

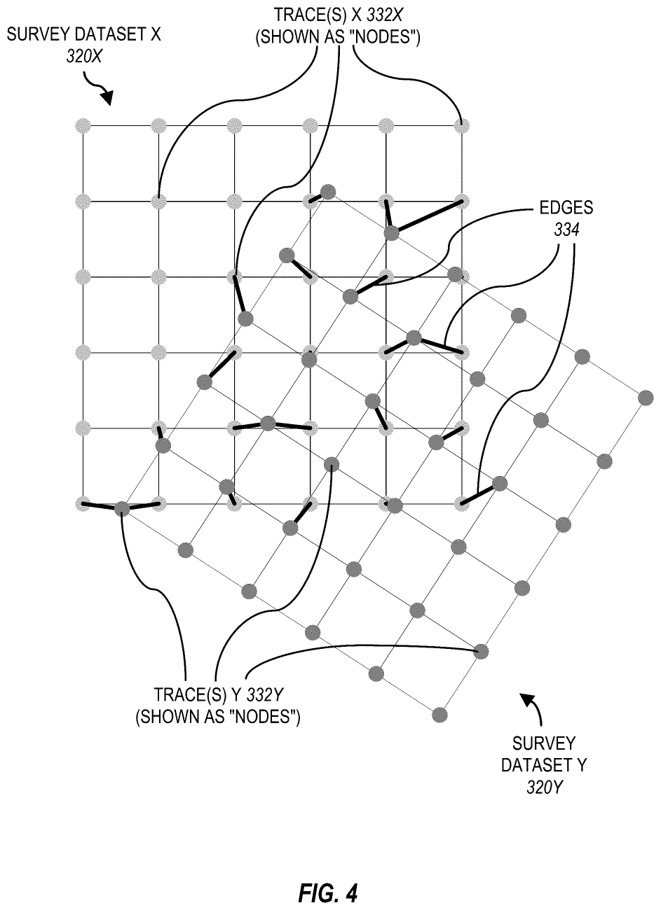

### FIG. 4

FIG. 4 is a diagram of two survey datasets and the edges between them.

Intra-edge 435 (e.g., intra-edges X 435X, intra-edges Y 435Y) is an edge 334 within a single survey dataset 320. That is, in one or more embodiments, traces 332 connected by intra-edge 435 are internal to a single survey dataset 320. In one or more embodiments, intra-edges 435 (among other data) are used when solving the system of equations (constraints and/or equalities) shown in Equation 1 (see the description of Step 510).

As shown in the example of FIG. 4, two survey datasets (survey dataset X 320X and survey dataset Y 320Y) are positioned and oriented with respect to each other, in a common space (e.g., a larger data structure). In one or more embodiments, as shown in FIG. 4, a graph data-structure (“graph”) without an inherent structure, may be used to represent two (or more) survey datasets 320, by encoding traces 332 as nodes (defined points, shown as grey circles on the grid) and edges 334 as the relative spatial information between traces 332 of different survey datasets 320.

In the example of FIGS. 3A-3E, position(s) 322 and depth(s) 324 are associated via a common external coordinate system (e.g., GPS) or known relationships between data therein (e.g., reflector(s) 326). The example of FIG. 4 shows that survey datasets 320 may be mapped using one or more dimension(s) of one or more type(s), spatial or signal-based (e.g., frequency, amplitude, etc.) via any system for correlation and association.

That is, in one or more embodiments, nodes can also represent samples in each trace 332 (e.g., pixels and/or voxels) in the survey dataset 320 and any additional value such as a seismic attribute can be assigned to the node. Edges 334 would then represent the spatial information between pixels/voxels on different traces 332, again encoding the spatial information. For traces 332 belonging to the same survey dataset 320, edges 334 may be defined by the structure of the regular grids themselves (e.g., as the relationship between the traces 332 within a survey dataset 320 is known by the structure of the survey dataset 320, alone).

For traces 332 belonging to different survey datasets 320, edges 334 may be added between nodes (traces 332) if they are within a set distance in the projected coordinate system. In this way a graph may be simply setup that connects all traces 332 from all survey datasets 320 to transform one or more selected survey datasets 320 into a consistent position/depth space. In one or more embodiments, there is no requirement to generate the graph using the same trace 332 spacing as in the original datasets. For efficient computation the graph may be constructed using a sparse set of traces 332 selected from each survey dataset 320. The sparse traces 332 from each survey dataset 320 may define a down sampled grid but can also be selected with any other sampling procedure.

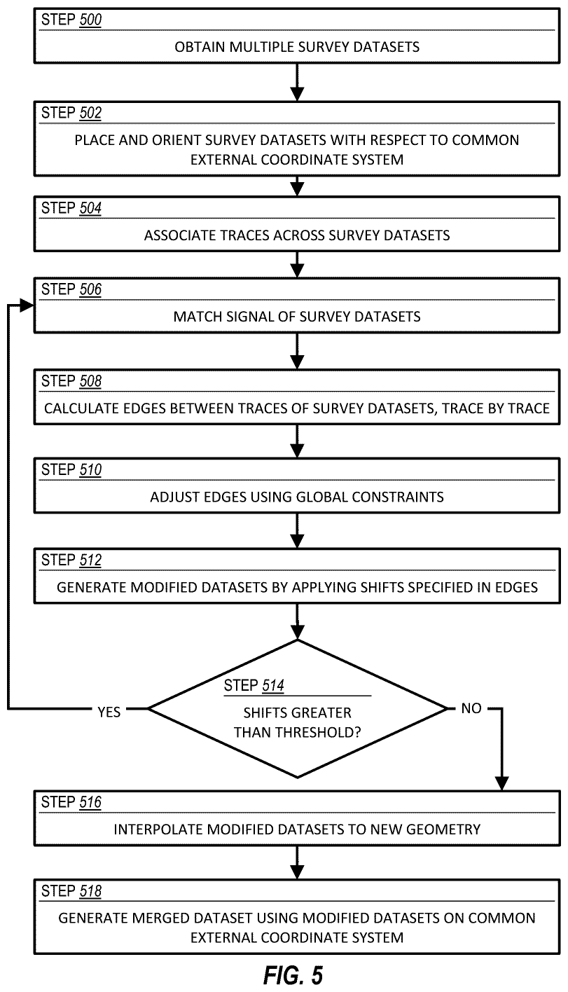

### FIG. 5

FIG. 5 is a flowchart of a method for generating a merged dataset from multiple datasets. All or a portion of the method shown may be performed by one or more components of information handling system 201 (see description in FIG. 2) or a user thereof. While the various steps in this flowchart are presented and described sequentially, a person of ordinary skill in the relevant art (having the benefit of this detailed description) would appreciate that some or all steps may be executed in different orders, combined, or omitted, and some or all steps may be executed in parallel.

In step 500, information handling system 201 obtains two (or more) survey datasets 320. Information handling system 201 may copy some or all of survey datasets 320 from database 214 (e.g., stored in storage 208) to memory 206 and/or cache 204 for processing by processor 202. In one or more embodiments, at any point throughout the process described in FIG. 5, various portions of survey datasets 320, modified dataset(s) 336, and any other data described herein may persist in cache 204, memory 206, storage 208, and may be moved between those devices as controlled by processor 202.

In step 502, information handling system 201 (or a user thereof) places, orients, aligns, or otherwise associates each survey dataset 320 to a common coordinate system. In one or more embodiments, two (or more) survey datasets 320 may overlap the same geographic region. However, each survey dataset 320 may only have an internal coordinate system that does not (inherently) relate to an external coordinate system outside of the individual survey dataset 320. Accordingly, metadata (or other known information) of survey datasets 320 may be used to provide an initial spatial relationship between survey datasets 320. As a non-limiting example, coordinates from a global navigation satellite system (GNSS), similar internal markers (e.g., matching patterns in reflector(s) 326), and measurable distances to an external location, may all be used to relate the internal coordinates of each survey dataset 320 to the internal coordinates of another survey dataset 320 and/or to some common external point. Further, in instances where the internal coordinate of multiple survey datasets 320 are related (with or without association to an external marker), those correlated survey datasets 320 may be placed in a common spatial dataset without an association to any external coordinate system (i.e., using the existing spatial relationships across the datasets).

In step 504, information handling system 201 identifies and associates one or more trace(s) 332 from one or more survey dataset(s) 320 to one or more trace(s) 332 of other survey dataset(s) 320. In one or more embodiments, trace(s) 332 from survey dataset(s) 320 may be associated via proximity (i.e., closest trace(s) 332 are paired with the nearest trace 332 of another survey dataset 320, within some threshold). Additionally, traces 332 from a first survey dataset 320 may be interpolated to the location of traces 332 in a second survey dataset 320, or they may both be interpolated to a common mid-point location. Such interpolation may be accomplished by conventional spatial interpolation, projection of traces based on local structural dip attributes, and/or a graph neural network. As a non-limiting example, as shown in FIG. 4, survey dataset X 320X includes trace(s) X 332X (shown as light grey dots on a grid) that are associated with trace(s) Y 332Y (shown as darker grey dots) of survey dataset Y 320Y.

In step 506, information handling system 201 (or a user thereof) matches the signal of survey datasets 320. In one or more embodiments, this matching of survey datasets 320 is designed to match the character of the signal(s) in the two surveys. Matching the signal of survey datasets 320 may be accomplished by (i) matching spectral character of the signals across survey datasets 320, (ii) defining a matching filter, and/or (iii) style transfer using a deep learning model.

In one or more embodiments, artificial intelligence (AI) (e.g., using deep neural networks (DNNs)) extracts features from data using neighborhood or overlapping traces 338 mapping to build an image-to-image network model. Further, in any embodiment, such models may be used to extract features from one dataset that are prevalent in an unrelated dataset. As a non-limiting example, an AI model may be trained to identify certain patterns in datasets where that pattern is prevalent. Then, that trained model may be used to exemplify, extract, or otherwise identify that pattern in an unrelated dataset. When trained, the model is able to correctly map the spectral characteristics of signal(s) of one survey dataset 320 to the spectral characteristics of signal(s) of another survey dataset 320. This includes, but is not limited to, mapping low frequency, low resolution seismic datasets to high frequency, high resolution seismic datasets. The architectures for such models may include, but are not limited to, multi-scale and cross-scale convolutional neural networks, generative adversarial neural networks (GAN), CycleGAN, and graph neural networks (GNN). In one or more embodiments, deep learning models are trained on synthetic data and used for inference on the field data (those of survey datasets 320).

In step 508, information handling system 201 calculates edge(s) 334 between the trace(s) 332 associated in step 504. In one or more embodiments, edge(s) 334 are calculated as an array of “shifts” to apply to the individual datapoints of edge(s) 334. In one or more embodiments, dynamic time warping (DTW) may be used to provide an initial calculation of the edge(s) 334 between traces 332. As a non-limiting example, dynamic time warping may use optimal matching to map individual datapoints of one trace 332 to individual datapoints to another trace 332, and such an operation may be performed for each pair of traces 332 (as associated in step 504). One of ordinary skill in the art (provided the benefit of this detailed description) would appreciate that any appropriate method may be used to calculate edges 334 (shifts) between traces 332 including using cross correlation, any neural network, radial basis function, and/or any other applicable function to generate edge(s) 334. The shifts are vectors specifying a magnitude and direction that the datapoints of the trace(s) 332 are modified (e.g., “shifted”) to generate shifted trace(s) 338 that provide for smoother and continuous reflector(s) 326 within merged dataset 340.

In step 510, information handling system 201 adjusts the edge(s) 334 (calculated in step 508) by minimizing globally defined constraints (i.e., “global constraint(s)”). That is, as a non-limiting example, edge(s) 334 are adjusted using criteria external to the specific points connected with adjacent trace(s) 332. Accordingly, some points within trace(s) 332 may be adjusted significantly more (or less) than other point(s) in other trace(s) 332 across the survey datasets 320—as controlled by the minimization of one or more equations specified in the global constraints.

$$[ \begin{matrix}w ( s ( {z}_{i} ) - s ( {y}_{i} ) ) \\ μ \frac{δ s}{δ z} \\ μ \frac{δ z}{δ h}\end{matrix} ] \approx [ \begin{matrix}w ( {z}_{i} - {y}_{j} ) \\ 0 \\ 0\end{matrix} ] \qquad ( 1 )$$

Equation (1) may mathematically represent a linear system that is constructed from the graph, where the first line may fit the global shifts s to the calculated shifts between traces connected by an inter-survey edge. The w term allows weighting to be applied so that the optimized shifts will preferentially fit the calculated shifts that have a lower uncertainty. The second two lines represent smoothing terms controlled by the scalar μ that are applied across all edges in the graph. In this way the final shifts may smoothly fit the calculated shifts between traces in the overlapping region and may smoothly decay to a background shift outside of this region. The final calculated vertical shifts when applied to each survey may map them into a consistent position/depth space.

In regions of survey dataset(s) 320 with complex geology or lower resolution, it is possible that the initial estimated shifts by this method may not map the survey as desired. Accordingly, in one or more embodiments, it is possible to further embed constraints into Equation (1) to help the optimization converge on the desired result. As a non-limiting example, if two points are known in two survey datasets 320 that are to be mapped to the same position/depth in the output, a linear equation is added as a constraint when solving Equation (1). Where the difference between the global shifts at the position of the two constraint points may be the same as the difference of those constraint points. This may be applied to any form of user input, whether it be direct user picks, or from the same horizon interpreted across multiple surveys. In this way, the final shifts may smoothly align shifted trace(s) 338 in the overlapping region and may smoothly decay to a background shift outside of this region. The final calculated vertical shifts, when applied to each survey, may map them into a consistent position/depth space.

In step 512, information handling system 201 generates modified dataset(s) 336 by applying edge(s) 334 (and the shift(s) specified therein) to trace(s) 332 associated with those edge(s) 334 to generate shifted trace(s) 338. In systems with many survey dataset(s) 320, it may be required to iteratively calculate and apply edges 334 to survey datasets to generate modified dataset(s) 336 that successfully minimize the constraints of Equation (1).

In step 514, information handling system 201 makes a determination if the shifts(s) applied to the modified dataset(s) 336 are greater than a threshold (sₜ). If information handling system 201 determines that the shifts are greater than (or equal to) the threshold (step 514—YES), then the method returns to step 506. However, if information handling system 201 determines that the shifts are less than the threshold (step 514—NO), the method proceeds to step 516.

In one or more embodiments, if the iterative steps of the process are performed (i.e., referring to the optional implementation of steps 506, 514, and 516), the shifts(s) calculated (applied to generate the modified dataset(s) 336) may be used to calculate sufficient compliance with convergence criteria (comparison to a threshold (sₜ)). Accordingly, steps 506, 508, 510, 512, and 514 may be repeated until the magnitude of the shifts (|Δs|) falls below the threshold (|Δs|<sₜ).

In one or more embodiments, when step 514 is initially or subsequently performed, a magnitude of the difference in traces between the original survey datasets and the modified dataset(s) 336 may be calculated for comparison to the threshold. Additionally, and/or alternatively, for any second or subsequent performance of step 514, shifts from the most recently generated modified dataset(s) 336 may be compared against the shifts previously calculated shifts. For each instance the shifts are greater than the provided threshold, the repeated steps are applied to the most newly generated modified dataset(s) 336 (i.e., newly generating modified dataset(s) 336 from the previously modified dataset(s) 336). Further, any other termination criteria may also be used to make the determination of step 514. Non-limiting examples include the difference in the output signals between iterations after shifts and matching has been applied, and the mean squared error between the amplitude or frequency spectra of the shifted traces connected by an inter-survey edge in the graph.

In step 516, information handling system 201 interpolates the modified dataset(s) 336 to a new geometry. In one or more embodiments, the new geometry is defined using the external coordinate system (or other structure). The new geometry consists of a grid of traces, the orientation of the grid and the density of traces can be defined in any way. In one or more embodiments, the grid may be a Cartesian grid. One of ordinary skill in the art (provided the benefit of this detailed description) would appreciate that any appliable grid system may be used (e.g., triangular, irregular, polar, cylindrical, etc.). Traces from the modified dataset(s) 336 may then be interpolated to this new geometry (e.g., similar to step 504).

In step 518, information handling system 201 generates merged dataset 340 by combining modified dataset(s) 336 to form a single merged dataset 340 (e.g., stitching the modified dataset(s) 336 into a single coordinate system). In one or more embodiments, datasets merged dataset 340 may include the external coordinate system used to initially place the survey datasets 320 together (e.g., using the external coordinate system used in step 502 as the internal coordinate system for merged dataset 340). The generated merged dataset 340 may then be used for analysis without needing to reference multiple, smaller survey datasets 320 of varying size and scale.

### Solutions and Improvements

The methods and systems described above are an improvement over the current technology as the methods and systems described herein provide for generating a merged dataset using multiple sets of already-processed data. The techniques described herein provide for generating “smooth” merged datasets, where any reflectors of the data are seamlessly continuous across the boundaries of the smaller datasets. Accordingly, in scenarios where raw, pre-processed seismic data is unavailable, or computational time and expense are undesirable, the methods and systems disclosed herein provide for directly merging already-processed survey datasets into a single, unified, and processed merged dataset which may be more quickly generated than when using conventional methods.

### Statements

The systems and methods may comprise any of the various features disclosed herein, comprising one or more of the following statements.
Statement 1. A method for generating a merged survey dataset, comprising: obtaining a plurality of survey datasets; calculating edges between survey datasets of the plurality of survey datasets; modifying the plurality of survey datasets, based on the edges, to obtain a plurality of modified survey datasets; and generating the merged survey dataset using the plurality of modified survey datasets.
Statement 2. The method of statement 1, wherein prior to calculating the edges, the method further comprises: generating associations between a first plurality of traces within a first survey dataset to a second plurality of traces within a second survey dataset.
Statement 3. The method of statement 2, wherein calculating the edges is based on the associations of the first plurality of traces with the second plurality of traces.
Statement 4. The method of statements 2-3, wherein modifying the plurality of survey datasets comprises: generating a plurality of modified datasets, using a global constraint, wherein the global constraint is applicable to each of the edges.
Statement 5. The method of statement 4, wherein modifying the plurality of survey datasets comprises: generating a first plurality of shifted traces, using the edges, from the first plurality of traces.
Statement 6. The method of statement 5, wherein a first modified dataset, of the plurality of modified datasets, comprises the first plurality of shifted traces.
Statement 7. The method of statement 6, wherein modifying the plurality of survey datasets comprises: generating a second plurality of shifted traces, using the edges, from the second plurality of traces.
Statement 8. The method of statement 7, wherein a second modified dataset, of the plurality of modified datasets, comprises the second plurality of shifted traces.
Statement 9. The method of statement 8, wherein the merged survey dataset comprises: the first plurality of shifted traces; and the second plurality of shifted traces.
Statement 10. The method of statements 8-9, wherein prior to calculating the edges, the method further comprises: matching a signal of each of the survey datasets, wherein matching the signal is one selected from the group consisting of: matching spectral character of the signals across survey datasets; defining a matching filter for the survey datasets; and style transfer using a deep learning model.
Statement 11. The method of statement 10, wherein after modifying the plurality of survey datasets, the method further comprises: making a determination that the first plurality of shifted traces does not exceed a threshold.
Statement 12. The method of statement 11, wherein the method further comprises: interpolating the first modified dataset with the second modified dataset based on the determination.
Statement 13. The method of statement 12, wherein generating the merged survey dataset is based on the interpolating of the first modified dataset with the second modified dataset.
Statement 14. The method of statements 10-13, wherein after modifying the plurality of survey datasets, the method further comprises: making a determination that the first plurality of shifted traces exceeds a threshold.
Statement 15. The method of statement 14, wherein the method further comprises: matching a second signal of each of the survey datasets, wherein matching the second signal is one selected from the group consisting of: matching spectral character of the signals across survey datasets; defining the matching filter for the survey datasets; and style transfer using the deep learning model.
Statement 16. The method of statements 1-15, wherein after to calculating the edges, the method further comprises: placing the plurality of survey datasets in an external coordinate system or associating each survey dataset of the plurality of survey datasets using an internal marker.
Statement 17. The method of statements 1-16, wherein prior to calculating the edges between the survey datasets, the method further comprises: constructing a graph; and logically placing the plurality of survey datasets in the graph.
Statement 18. The method of statement 17, wherein the edges between the survey datasets are calculated in the graph.
Statement 19. A method for generating a merged survey dataset, comprising: obtaining a first survey dataset; obtaining a second survey dataset; providing a spatial association between the first survey dataset and the second survey dataset; calculating an edge between the first survey dataset and the second survey dataset, by optimizing the edge to a plurality of global constraints; and generating the merged survey dataset use the edge.
Statement 20. An information handling system, comprising: storage, comprising a plurality of survey datasets; and a processor, wherein the processor is configured to perform a method for generating a merged survey dataset, comprising: calculating edges between survey datasets of the plurality of survey datasets; modifying the plurality of survey datasets, based on the edges, to obtain a plurality of modified survey datasets; and generating the merged survey dataset using the plurality of modified survey datasets.

### General Notes

As it is impracticable to disclose every conceivable embodiment of the technology described herein, the figures, examples, and description provided herein disclose only a limited number of potential embodiments. A person of ordinary skill in the relevant art would appreciate that any number of potential variations or modifications may be made to the explicitly disclosed embodiments, and that such alternative embodiments remain within the scope of the broader technology. Accordingly, the scope should be limited only by the attached claims. Further, the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the elements that it introduces. Certain technical details, known to those of ordinary skill in the relevant art, may be omitted for brevity and to avoid cluttering the description of the novel aspects.

For further brevity, descriptions of similarly named components may be omitted if a description of that similarly named component exists elsewhere in the application. Accordingly, any component described with respect to a specific figure may be equivalent to one or more similarly named components shown or described in any other figure, and each component incorporates the description of every similarly named component provided in the application (unless explicitly noted otherwise). A description of any component is to be interpreted as an optional embodiment—which may be implemented in addition to, in conjunction with, or in place of an embodiment of a similarly-named component described for any other figure.

### Lexicographical Notes

As used herein, adjective ordinal numbers (e.g., first, second, third, etc.) are used to distinguish between elements and do not create any ordering of the elements. As an example, a “first element” is distinct from a “second element”, but the “first element” may come after (or before) the “second element” in an ordering of elements. Accordingly, an order of elements exists only if ordered terminology is expressly provided (e.g., “before”, “between”, “after”, etc.) or a type of “order” is expressly provided (e.g., “chronological”, “alphabetical”, “by size”, etc.). Further, use of ordinal numbers does not preclude the existence of other elements. As an example, a “table with a first leg and a second leg” is any table with two or more legs (e.g., two legs, five legs, thirteen legs, etc.). A maximum quantity of elements exists only if express language is used to limit the upper bound (e.g., “two or fewer”, “exactly five”, “nine to twenty”, etc.). Similarly, singular use of an ordinal number does not imply the existence of another element. As an example, a “first threshold” may be the only threshold and therefore does not necessitate the existence of a “second threshold”.

As used herein, the word “data” may be used as an “uncountable” singular noun—not as the plural form of the singular noun “datum”. Accordingly, throughout the application, “data” is generally paired with a singular verb (e.g., “the data is modified”). However, “data” is not redefined to mean a single bit of digital information. Rather, as used herein, “data” means any one or more bit(s) of digital information that are grouped together (physically or logically). Further, “data” may be used as a plural noun if context provides the existence of multiple “data” (e.g., “the two data are combined”).

As used herein, the term “operative connection” (or “operatively connected”) means the direct or indirect connection between devices that allows for the transmission of data. For example, the phrase ‘operatively connected’ may refer to a direct connection (e.g., a direct wired or wireless connection between devices) or an indirect connection (e.g., multiple wired and/or wireless connections between any number of other devices connecting the operatively connected devices).

As used herein, indefinite articles “a” and “an” mean “one or more”. That is, the explicit recitation of “an” element does not preclude the existence of a second element, a third element, etc. Further, definite articles (e.g., “the”, “said”) mean “any one of” (the “one or more” elements) when referring to previously introduced element(s). As an example, there may exist “a processor”, where such a recitation does not preclude the existence of any number of other processors. Further, “the processor receives data, and the processor processes data” means “any one of the one or more processors receives data” and “any one of the one or more processors processes data”. It is not required that the same processor both (i) receive data and (ii) process data. Rather, each of the steps (“receive” and “process”) may be performed by different processors.

What is claimed is:

1. A method for generating a merged survey dataset, comprising:
obtaining a plurality of survey datasets;
calculating edges between survey datasets of the plurality of survey datasets;
modifying the plurality of survey datasets, based on the edges, to obtain a plurality of modified survey datasets; and
generating the merged survey dataset using the plurality of modified survey datasets.

2. The method of claim 1, wherein prior to calculating the edges, the method further comprises:
generating associations between a first plurality of traces within a first survey dataset to a second plurality of traces within a second survey dataset.

3. The method of claim 2, wherein calculating the edges is based on the associations of the first plurality of traces with the second plurality of traces.

4. The method of claim 2, wherein modifying the plurality of survey datasets comprises:
generating a plurality of modified datasets, using a global constraint, wherein the global constraint is applicable to each of the edges.

5. The method of claim 4, wherein modifying the plurality of survey datasets comprises:
generating a first plurality of shifted traces, using the edges, from the first plurality of traces.

6. The method of claim 5, wherein a first modified dataset, of the plurality of modified datasets, comprises the first plurality of shifted traces.

7. The method of claim 6, wherein modifying the plurality of survey datasets comprises:
generating a second plurality of shifted traces, using the edges, from the second plurality of traces.

8. The method of claim 7, wherein a second modified dataset, of the plurality of modified datasets, comprises the second plurality of shifted traces.

9. The method of claim 8, wherein the merged survey dataset comprises:
the first plurality of shifted traces; and
the second plurality of shifted traces.

10. The method of claim 8, wherein prior to calculating the edges, the method further comprises:
matching a signal of each of the survey datasets, wherein matching the signal is one selected from the group consisting of:
matching spectral character of the signals across survey datasets;
defining a matching filter for the survey datasets; and
style transfer using a deep learning model.

11. The method of claim 10, wherein after modifying the plurality of survey datasets, the method further comprises:
making a determination that the first plurality of shifted traces does not exceed a threshold.

12. The method of claim 11, wherein the method further comprises:
interpolating the first modified dataset with the second modified dataset based on the determination.

13. The method of claim 12, wherein generating the merged survey dataset is based on the interpolating of the first modified dataset with the second modified dataset.

14. The method of claim 10, wherein after modifying the plurality of survey datasets, the method further comprises:
making a determination that the first plurality of shifted traces exceeds a threshold.

15. The method of claim 14, wherein the method further comprises:
matching a second signal of each of the survey datasets, wherein matching the second signal is one selected from the group consisting of:
matching spectral character of the signals across survey datasets;
defining the matching filter for the survey datasets; and
style transfer using the deep learning model.

16. The method of claim 1, wherein after to calculating the edges, the method further comprises:
placing the plurality of survey datasets in an external coordinate system or associating each survey dataset of the plurality of survey datasets using an internal marker.

17. The method of claim 1, wherein prior to calculating the edges between the survey datasets, the method further comprises:
constructing a graph; and
logically placing the plurality of survey datasets in the graph.

18. The method of claim 17, wherein the edges between the survey datasets are calculated in the graph.

19. A method for generating a merged survey dataset, comprising:
obtaining a first survey dataset;
obtaining a second survey dataset;
providing a spatial association between the first survey dataset and the second survey dataset;
calculating an edge between the first survey dataset and the second survey dataset, by optimizing the edge to a plurality of global constraints; and
generating the merged survey dataset use the edge.

20. An information handling system, comprising:
storage, comprising a plurality of survey datasets; and
a processor, wherein the processor is configured to perform a method for generating a merged survey dataset, comprising:
calculating edges between survey datasets of the plurality of survey datasets;
modifying the plurality of survey datasets, based on the edges, to obtain a plurality of modified survey datasets; and
generating the merged survey dataset using the plurality of modified survey datasets.
